(19) United States
(12) Patent Application Publication
(10) Pub. No.: US 2020/0314204 A1
(43) Pub. Date: Oct. 1, 2020

(54) METHOD FOR OPERATING A NETWORK-AWARE CONTAINER ORCHESTRATION SYSTEM

(71) Applicant: Siemens Aktiengesellschaft, Munchen (DE)

(72) Inventors: Jürgen Gesswein, Augsburg (DE); Harald Müller, Seefeld-Hechendorf (DE); Sreenath Premnadh, Unterhaching (DE); Johannes Riedl, Ergolding (DE); Vivek Sriram Yenamandra Guruvenkata, Lawrenceville, NJ (US)

(21) Appl. No.: 16/365,965

(22) Filed: Mar. 27, 2019

(51) Int. Cl. H04L 29/08; H04L 12/24

(52) U.S. Cl. CPC H04L 67/32; H04L 41/22

(57) ABSTRACT

A method for operating a container orchestration system is disclosed, including a scheduling function means, being designed and configured to map industrial applications A decomposed into application components on an infrastructure represented by a plurality of compute nodes connected by a communication network including a plurality of network elements, a network control function means being designed and configured to control a plurality of communication services provided with the communication network, and an interface means being designed and configured to manage interactions between the scheduling function means and the network control function means. The method takes into consideration the properties of the network connecting compute nodes when scheduling distributed applications on them. Characteristics of the coupled network like bandwidth, latency, real-time behavior, availability, or the like are considered explicitly.

### FIELD OF TECHNOLOGY

The present invention pertains to a method for operating a container orchestration system comprising a scheduling function means, a network control function means, and an interface means designed and configured to manage interactions between the scheduling function means and the network control function means. Further, the invention pertains to a software application using the method and to a system equipped with a hardware structure on which the method according to the invention is run.

### BACKGROUND

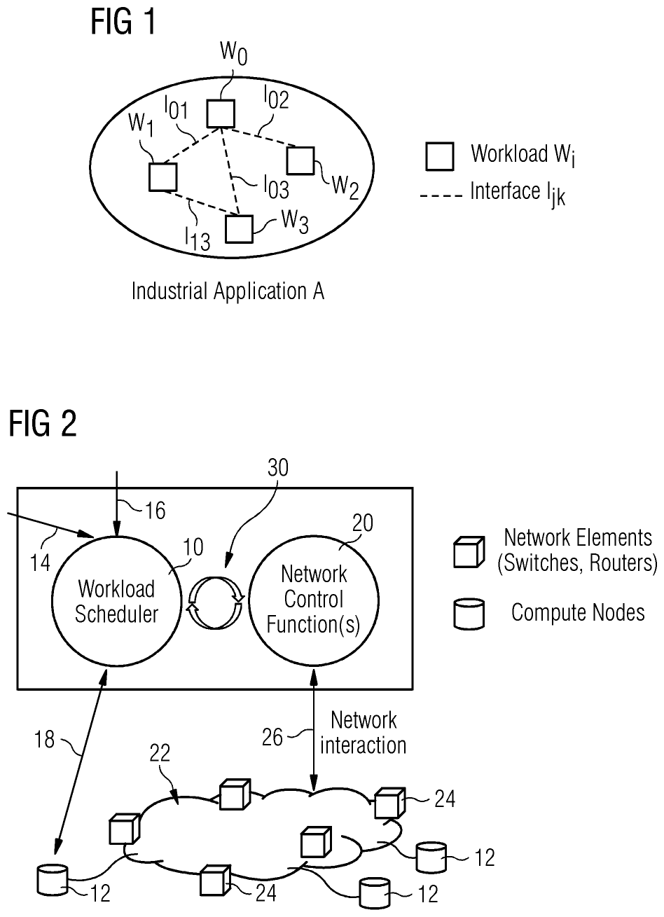

Applications A, especially industrial applications A, usually consist of several dependent application components (subsequently also called workloads Wᵢ) that exchange data via inter-faces Iⱼₖ, as depicted in FIG. 1, for example. Such a modular system usually only works if all workloads and interfaces are working properly and if certain boundary conditions are met. The challenge to meet the requirements and constraints of a series of industrial applications Aᵢ when mapping this series of industrial applications Aᵢ to a certain infrastructure can be solved by considering the interdependencies between components of an application, as described elsewhere.

A state-of-the art technology to implement modular software are so-called containers (like, e.g., “Docker”). Workloads can be packaged into containers, that can be run on a single or multiple container clusters. State-of-the-art technologies to manage multiple containers on a cluster are so-called container orchestration technologies (like, e.g., “Kubernetes”). Kubernetes comprises a scheduler that allocates so-called pods (which is a collection of containers) onto a set of nodes within a cluster.

The applications are modeled and mapped to an infrastructure consisting of compute nodes, links, and network nodes. This process is called scheduling. The compute nodes can be either closely located or distant, which means that the network can consist of local area network(s) (LAN) and/or wide area network(s) (WAN), and the network components can have a wide range of properties.

As mentioned before, one possible way to deploy industrial applications is by using software containers and use container orchestration technologies like Kubernetes to manage these containers. One problem that is still not addressed in current container orchestration systems is how to consider the network topology and condition while scheduling workloads to compute nodes, i.e. to consider network properties like bandwidth, latency, or reliability, and match those with the requirements and boundary conditions of the application.

In connection with the distribution of the application, i.e. the mapping of the application components over a plurality of computing nodes spaced apart from each other a couple of network-related problems may occur, which can have an influence on workload distribution and processing. These problems may refer, for example, to the question of how the scheduler gets the required information about the network, to the question which level of abstraction of the real network topology and condition is needed to take a scheduling decision, to the question how the network information can be kept up to date, to the question how the network information can be considered in the scheduling decision and/or to the question how application requirements can be composed to influence/enable scheduling decisions.

As to software defined networks and network controllers, they can be used to set up network connections with defined properties, such as maximum latency, reserved bandwidth etc. between two (or more) defined endpoints in the network. These points could be two workloads Wᵢ exchanging data. However, software defined networks and network controllers do not influence the distribution of the workloads Wᵢ on connection endpoints, i.e. they do not provide or perform workload scheduling.

### SUMMARY

To overcome the above problems, it is an object of the present invention to provide a method for operating a container orchestration system, which maps application components to compute nodes and which takes into consideration the properties of the network connecting compute nodes when scheduling distributed applications on them. The goal is to explicitly consider characteristics like bandwidth, latency, real-time behavior, availability, etc., of the network coupled with the requirements of applications and its constituent workloads when scheduling them to a geographically dispersed set of compute nodes. This process is called network aware scheduling throughout the application documents.

In accordance with the present invention, the object is achieved by a new method for operating a container orchestration system as recited in claim 1. According to that, the new method is based on the interaction of a scheduling function means, a network control function means, and an interface means managing interactions between the scheduling function means and the network control function means each of which provided with the container orchestration system, performing the method steps:
receiving at least one network-related requirement of the application and/or the application components by the scheduling function means;
interacting of the scheduling function means and the network control function means with one another via the interface means;
requesting required network connections between compute nodes selected by the scheduling function means;
establishing a suitable solution by both the scheduling means and the network control function means fulfilling all requirements requested;
executing a scheduling decision by the scheduling function means based on the solution found before;
mapping of application components Wᵢ of the application A to the respective selected compute nodes by the scheduling function means;
setting up required communication services in the communication network by the network controller function means;
   that do not necessarily have to take place in that order and may also take place, at least in part, simultaneously.

For the sake of simplicity, the communication network may simply be referred to as the (underlying) network as well as the scheduling function means may be referred to as the scheduler and the network control function means may be referred to as the network controller, respectively. Further, network elements may be referred to as network nodes.

Accordingly, the present invention is based on the idea that the described method considers the properties of the network connecting the compute nodes when scheduling distributed applications on them. This allows the network control function means to consider the location of endpoints for communication services and at the same time to care about influencing the placement of workloads on these endpoints (scheduling). Further, the method according to the invention enables combinations of network controller or software defined network with the scheduler of container orchestration systems to build the complete functionality of placement of workloads (scheduling) with consideration of the underlying network.

As to the general concept, the system of realizing a network aware scheduling function means is as follows:

The scheduling function means of the container orchestration system (further on called scheduler) is extended to also receive network-related requirements of the application A and/or the application components W₁, . . . , Wₙ. This approach uses a network model that consists of links L and network nodes N, as described elsewhere. The network connects compute nodes C.

In the general concept, this invention introduces:
a network control function means, further on also referred to as the network controller(s), as additional component(s) in the container orchestration system;
an interface and one or many additional interactions through this interface between the scheduler and the network controller during the scheduling process.

Moreover, an abstract network model that is used to exchange information between the scheduler and the network controller in order to control the setup of connections in the network.

From the abstract network model, the scheduler has some knowledge about the underlying network and thus about the connectivity between compute nodes in the cluster it controls (but in the general case not down to the detail). This network knowledge is usually constructed from previous interactions with the network controller. The scheduler uses this knowledge to come up with a scheduling attempt (i.e. assignment of the workloads Wᵢ of an application A to a set of compute nodes).

Using the abstract network model, the scheduler interacts with the network controller to request the required network connections between the selected compute nodes. When a suitable solution has been found by both the scheduler and the network control function(s) that fulfills all provided requirements, the deployment of the workloads Wᵢ of application A to the selected compute nodes is done by the scheduler, and the setup of the required communication services in the communication network is done by the network controller function(s).

A number of preferred features and beneficial improvements of the invention are recited in the dependent claims.

According to a preferred embodiment, the method according to the invention further includes
checking by the scheduling means whether a change of the network situation occurring during operation impacts the deployed application and/or application component(s) in a way that requirements can no longer be met;
rescheduling of one or more applications or application components, if necessary.

In case the network situation changes during operation, e.g. due to a link or node failure or due to changed traffic conditions, the network control function will get to know about that and informs the scheduler. The scheduler checks whether this situation impacts the deployed applications in a way that requirements can no longer be met. This is again done by interaction between the scheduler and the network controller function.

According to another embodiment, the network control function means used in the method according to the invention is designed and configured to performing at least one of
performing automated network bootstrapping, network topology detection including collecting of all relevant network properties;
receiving so-called network slice requests to setup a virtual communication network on a physical communication network for a specific tenant while providing service guarantees as defined in the request in an abstract way;
receiving so-called communication service requests to establish a connectivity relation within a network slice while providing the service guarantees as defined in the request in an abstract way;
taking care about all required configurations and parametrizations in the communication network to setup the requested network slice/communication service guarantees.

Thus, the network control function means does not consider the location of endpoints for a communication service any longer as given, it rather does care about influencing the placement of workloads on these endpoints (scheduling). Accordingly, a combination of network controller or software defined network with the scheduler of container orchestration systems now enables the scheduling function means to build the complete functionality of placement of workloads (scheduling) with consideration of the underlying network.

According to another preferred embodiment of the present invention, major network related requirements may be represented by at least one of parameters of latency, bandwidth, availability, error rate, etc., whereby latency may be expressed in different descriptions, e.g. maximum, mean, minimum, jitter, statistics. Further parameters not mentioned, but related to network conditions can also be taken into account. While more complex considerations of network conditions take into account a plurality of those parameters, only a subset of these parameters may be used in a simpler implementation of this invention.

According to another embodiment of the present invention, the scheduling decision of mapping of application components to compute nodes is based on best effort or some heuristics and sending it to the network control function means for verification.

This variant of the invention is that the scheduler does not have upfront information about the network. It does a scheduling decision (mapping of workloads to compute nodes) based on best effort or some heuristics and sends it to the network controller for verification. If the network controller function is not able to setup all communication services, the scheduler's request will be denied including the information which compute nodes could not be connected according to the requirements. The network controller function has to be extended to provide this reason code in case of a failed communication service setup. Subsequently, the scheduler uses this information to update his scheduling policy and proposes a different assignment of compute nodes with the workloads. A simple way to do this may be that all compute nodes which led to a not fulfillable connectivity requirement are excluded from the next schedule calculation. This process is continued until the network controller function confirms the setup of required network services, or the scheduler concludes that there is no possible solution at this point in time.

According to another variant of the present invention a connectivity matrix is used by the scheduling function means for approximately checking whether the network-related requirements can be fulfilled for a chosen schedule. This variant is based on a description of the network with a connectivity matrix CM between all compute nodes C (CM=C×C), where CMᵢⱼ represents the connection between compute nodes Cᵢ and Cⱼ. Each element CMᵢⱼ is a vector of different network parameters like bandwidth, latency, availability, etc. The network parameters describe the network resources that are currently available, i.e. if a connection is used, the resource parameters (e.g. bandwidth) will reduce by a certain amount.

The connectivity matrix is used by the scheduler to approximately check whether the network related requirements can be fulfilled for a chosen schedule.

According to another variant of the present invention, a prediction, by the scheduler, whether a chosen deployment will work from a network point of view is considered. In this variant, the scheduler is very closely integrated with the network controller function in the sense that the network model comprises of the complete detail of the network (including all network segments and network nodes). This allows the scheduler to predict with very high certainty, whether a chosen deployment will work from a network point of view. In consequence, a schedule will fail only in very rare occasions. However, this variant requires extensive exchange of network information, and the scheduling decision becomes more complex.

According to another variant of the present invention, the network is divided into parts and several network controlling function means are provided each controlling one of the parts of the network. In this variant of the method only part of the network may be controlled by the network controlling function means. This may e.g. be useful, when a network controller controls only an on premise network, while the wide area network is out of its scope. The network controller may specify the scope of the network it is able to control. One example case for this is a plant network in a factory, that can, e.g., also include real-time critical industrial automation and control applications.

According to another variant of the present invention, several application orchestration instances are provided each scheduling application components Wᵢ on its assigned infrastructure, the respective infrastructure overlapping with the infrastructure of at least one different instance at least in part.

According to another variant of the present invention, a network probe is installed on each compute node or a subset of compute nodes monitoring network conditions and properties and communicating them to the scheduling function means or the network controlling function means. In this variant, network probes measure and monitor network conditions and properties, and communicate them to the scheduler or the network controller. This may be done in a fully meshed way (i.e. from every compute node to every other compute node). The network probes may run in containers and be deployed using the container orchestration system itself.

According to another variant of the present invention, the network communication services are setup by the compute nodes themselves. In this variant, the network services are setup by the compute nodes themselves rather than by a network controller on instruction from the scheduler, which reduces network traffic and increases the bandwidth available.

According to another variant of the present invention, compute delays in the compute nodes are (additionally) considered by the scheduler to calculate end-to-end delays between a set of workloads and interfaces between them. In a variant, the scheduler not only considers the network delays, but also the compute delays in the compute nodes to calculate end-to-end delays between a set of workloads and interfaces between them.

In a preferred variant, reservations for the real-time workloads and data flows are to be provided with the underlying infrastructure. In order to guarantee real-time behavior, the underlying infrastructure needs to make reservations for the real-time workloads and data flows. For the network services, this is done via the scheduler to network controller interface by including appropriate properties of the network services.

According to an embodiment of the present invention, the scheduling function means is either implemented as a custom scheduler or as a component preselecting possible network nodes and interacting with a network controller, and marking them in a deployment file accordingly, before calling the existing scheduler. In this variant, e.g., Kubernetes may be used as the container orchestrator. The network aware scheduler is either implemented as a custom scheduler or as a component that preselects possible nodes (considering the described approach and interacting with a network controller) and marking them in a deployment file accordingly, before calling the existing Kubernetes scheduler.

According to another aspect of the invention, the above-mentioned object is also achieved with a software application using the method discussed above, wherein the scheduler is implemented into a custom scheduler to be integrated into common software tools by providing appropriate extension interfaces.

According to a variant, with the software application using the method according the scheduler is a part of a container orchestrator of a system, which packages the workloads into containers, which are managed during runtime by a container orchestrator. For this purpose, the respective orchestrator (like, e.g., Kubernetes) may already have a simple scheduler. This scheduler could be extended to fulfill the functions described in the invention. In a second variant, a custom scheduler could be implemented for Kubernetes. There are appropriate extension interfaces available in Kubernetes to use custom schedulers.

Further, according to another aspect of the invention, the above-mentioned object is also achieved with a container orchestration system for mapping industrial applications equipped with a hardware structure and configured to run the method discussed above, especially an above-mentioned software application.

The invention with its different aspects as outlined above has the following advantages and benefits in taking information about the underlying network into consideration when scheduling workloads of an application onto compute nodes:
Applications can be distributed onto a dispersed compute cluster, while fulfilling requirements in terms of
   latency;
   bandwidth (required data rate;
   response time;
   availability;
   security (e.g., privacy zones, encryption);
   etc.
A container orchestration system can support (industrial) applications with (a subset of) the above requirements;
Scheduling decisions can be done automatically, considering network aspects. No manual configuration or engineering is required to achieve the desired application behavior;
Information about the network is automatically detected and frequently updated by the network controller. This reduces manual configuration of such information in the scheduler, while improving the accuracy of such information;
Information about network conditions is frequently updated and the system can adapt to changing network conditions. This allows for improving reliability and availability of applications.
Parts of an application can make dedicated use of more remote (cloud) compute resources, only for those parts of the application that can afford the network implications (delay, etc.). This can happen automatically.

### BRIEF DESCRIPTION

For a more complete understanding of the invention and the advantages thereof, exemplary embodiments of the invention are explained in more detail in the following description with reference to the accompanying drawings, in which like reference characters designate like parts and in which:

FIG. 1 represents a schematic view of an example of an application model of an industrial application Aᵢ in the method according to the invention decomposed into so-called workloads Wᵢ communicating via interfaces;

FIG. 2 represents a schematic view of an example of the general concept of a network aware scheduling using a scheduling function means (“Workload Scheduler”) and a network control function means interacting via an interface means;

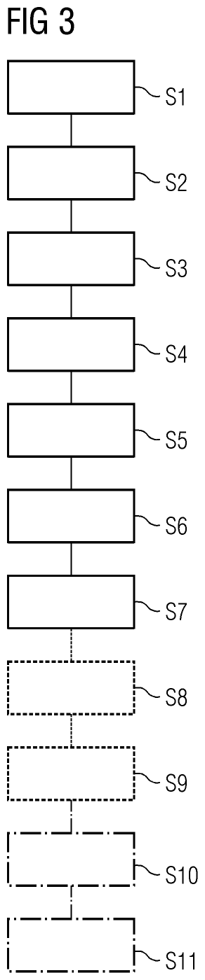

FIG. 3 represents a schematic view of the method according to the invention with method steps S₁ to S₇ representing the mapping of workloads Wi to compute nodes taking into consideration network conditions by interaction of a scheduling function means and a network control function means with one another via an interface means, whereby a suitable solution by both the scheduling means and the network control function means fulfilling all requirements requested is established and a scheduling decision is made and executed; Additionally, optional method steps S₈ to S₁₁ are also shown;

The accompanying drawings are included to provide a further understanding of the present disclosure and are incorporated in and constitute a part of this specification. The drawings illustrate particular embodiments of the invention and together with the description serve to explain the principles of the invention. Other embodiments of the invention and many of the attendant advantages of the invention will be readily appreciated as they become better understood with reference to the following detailed description.

### DETAILED DESCRIPTION

It will be appreciated that common and well understood elements that may be useful or necessary in a commercially feasible embodiment are not necessarily depicted in order to facilitate a more abstracted view of the embodiments. The elements of the drawings are not necessarily illustrated to scale relative to each other. It will further be appreciated that certain actions and/or steps in an embodiment of a method may be described or depicted in a particular order of occurrences while those skilled in the art will understand that such specificity with respect to sequence is not necessarily required. It will also be understood that the terms and expressions used in the present specification have the ordinary meaning as is accorded to such terms and expressions with respect to their corresponding respective areas of inquiry and study, except where specific meanings have otherwise been set forth herein.

The same or functionally equivalent elements and devices have been put on the same reference signs in all figures provided that nothing else is indicated.

With reference firstly to FIG. 1 of the drawings, a schematic view of an example of an application model of a single industrial application A in the method according to the invention decomposed into so-called workloads Wᵢ communicating via interfaces Iⱼₖ is represented. Obviously, the application model shown is modular with the application A decomposed into the workloads Wᵢ each of which represents an application component executing computational tasks, and exchanging data via interfaces Iⱼₖ with other components.

Turning to FIG. 2 of the drawings now, a schematic view of the general concept of a network aware scheduling is shown. A workload scheduling representing the scheduling function means 10 interacts with a network control function means 20 represented by a network controller. The interaction carried out by the interaction means 30 is symbolized by the two curved arrows arranged between the scheduling function means 10 and the network control function means 20 in FIG. 2. The interaction takes place in order to clarify the networking capabilities of the network 22 which is made up of network element 24 communicating with each other and with the network control function means 20.

The schedule function means 10 is aware of available distributed compute nodes 12 in the network including free resources for each node, which awareness is symbolized by the arrow 14. At the same time, the schedule function means 10 is aware of the different distributed application components Wᵢ including their compute and network requirements, which further awareness is symbolized by the arrow 16. While the network control function means interacts with the network and its elements, symbolized by arrow 26, the schedule function means 10 deploys the application components Wᵢ, . . . , Wₙ to the compute nodes 12 and receives feedback from the compute nodes 12, which is symbolized by arrow 18.

The compute nodes 12 are instances of computational units, they can either be bare metal hardware nodes or virtual machines and may reside in different compute domains-cloud domain, datacenter domain, edge domain, and device domains.

Furthermore, the network elements 24 shown in FIG. 2 of which the network is made up correspond to physical or virtual network devices like switches or routers. Besides providing connectivity of links, a network element 24 may have properties, including minimum latency (in ms), jitter (in ms), realtime class, etc. Network links (not shown in FIG. 2) may have properties, including minimum latency (in ms), jitter (in ms), availability, etc.

From the abstract network model, the scheduling function means (scheduler) 10 has some knowledge about the underlying network 22 and thus about the connectivity between compute nodes 12 in the cluster it controls (but in the general case not down to the detail). This network knowledge is usually constructed from previous interactions with the network control function means (network controller) 20. The scheduler 10 uses this knowledge to come up with a scheduling attempt (i.e. assignment of the workloads Wᵢ of an application A to a set of compute nodes 12).

Using the abstract network model, the scheduler 10 interacts with the network controller 20 to request the required network connections between the selected compute nodes 12. When a suitable solution has been found by both the scheduler 10 and the network control function(s) 20 that fulfills all provided requirements, the deployment 18 of the workloads Wᵢ of application A to the selected compute nodes 12 is done by the scheduler 10, and the setup of the required communication services in the communication network 22 is done by the network controller function(s) 20.

In case the network situation changes during operation, e.g. due to a link or node failure or due to changed traffic conditions, the network control function means 20 will get to know about that and informs the scheduler 10. The scheduler checks whether this situation impacts the deployed application components in a way that requirements can no longer be met. This is again done by interaction between the scheduler 10 and the network controller function means 20 via the interface 30.

In order to provide a method for operating a container orchestration system that considers the network topology and condition while scheduling workloads Wᵢ to compute nodes 12, i.e. to consider network properties like bandwidth, latency, or reliability, and match those with the requirements and boundary conditions of the application A, as schematically shown in FIG. 3, and according to above explanations, the present disclosure pertains to a method for operating a container orchestration system, the system comprising a scheduling function means 10, which designed and configured to map industrial applications A decomposable or decomposed into application components Wₗ, . . . , Wₙ on an infrastructure represented by a plurality of compute nodes 12 connected by a communication network 22 comprising a plurality of network elements 24. The system further comprises a network control function means 20, which is designed and configured to control a plurality of communication services provided with the communication network 22 and an interface means 30, which is designed and configured to manage interactions between the scheduling function means 10 and the network control function means 20.

The method includes the method steps of:
receiving (S1) at least one network-related requirement of the application A and/or the application components Aᵢ by the scheduling function means 10;
interacting (S2) of the scheduling function means 10 and the network control function means 20 with one another via the interface means 30;
requesting (S3) required network connections between compute nodes 12 selected by the scheduling function means 10;
establishing (S4) a suitable solution by both the scheduling means 10 and the network control function means 20 fulfilling all requirements requested;
executing (S5) a scheduling decision by the scheduling function means 10 based on the solution found before;
mapping (S6) of application components Wᵢ of the application A to the respective selected compute nodes 12 by the scheduling function means 10;
setting up (S7) required communication services in the communication network 22 by the network controller function means 20;

What also can be taken from FIG. 3 are optional extensions of the method indicated by dotted or dashed lines in the schematic diagram in steps S8 through S11, which represent the method extended on the one hand by the steps
checking (S8) the networking situation continuously by the network controller function means 20; and
further interacting (S9) of network control function means 20 and scheduling function means 10 at least in case of a change of the network situation occurring during operation; and on the other hand by the steps
checking (S10) by the scheduling function means 10 whether a change of the network situation occurring during operation impacts the deployed application A and/or application component(s) Wᵢ, . . . , Wₙ in a way that requirements can no longer be met;
rescheduling (S11) of one or more applications or application components, if necessary, by the scheduling function means.

The above-mentioned considerations of interdependencies are specifically important for industrial applications Aᵢ in many business fields as distributed control systems, building automation, industrial automation and control.

For example, the described method can be used to deploy and operate applications A that are distributed across several compute domains spanning from cloud to edge/device domain.

Further, the described method decreases time to market and increases flexibility of deploying industrial applications A by making it able to map workloads Wᵢ to compute nodes in the cloud, datacenter or edge/device domain at deploy time or even at run time. This reduces engineering efforts at design time and deploy time.

Although specific embodiments of the invention have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

In this document, the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their object.

1. A method for operating a network-aware container orchestration system, the system comprising
a scheduling function means, being designed and configured to map industrial applications A decomposable or decomposed into application components on an infrastructure represented by a plurality of compute nodes connected by a communication network comprising a plurality of network elements;
a network control function means being designed and configured to control a plurality of communication services provided with the communication network; and
an interface means being designed and configured to manage interactions between the scheduling function means and the network control function means;
the method including:
receiving at least one network-related requirement of the application A and/or the application components Wᵢ by the scheduling function means;
interacting of the scheduling function means and the network control function means with one another via the interface means;
requesting required network connections between compute nodes selected by the scheduling function means;
establishing a suitable solution by both the scheduling function means and the network control function means fulfilling all requirements requested;
executing a scheduling decision by the by the scheduling function means based on the solution found before;
mapping of application components Wᵢ of the application A to the respective selected compute nodes by the scheduling function means;
setting up required communication services in the communication network by the network controller function means.

2. The method according to claim 1, further including:
checking the networking situation continuously by the network controller function means; and
further interacting of network control function means and scheduling means at least in case of a change of the network situation occurring during operation.

3. The method according to claim 1, further including:
checking by the scheduling function means whether a change of the network situation occurring during operation impacts the deployed application A and/or application component(s) Wᵢ, . . . , Wₙ in a way that requirements can no longer be met;
rescheduling of one or more applications or application components, if necessary.

4. The method according to claim 1, wherein the network control function means is designed and configured to performing at least one of
performing automated network bootstrapping, network topology detection including collecting of all relevant network properties;
receiving so-called network slice requests to setup a virtual communication network on a physical communication network for a specific tenant while providing service guarantees as defined in the request in an abstract way;
receiving so-called communication service requests to establish a connectivity relation within a network slice while providing the service guarantees as defined in the request in an abstract way;
taking care about all required configurations and parametrizations in the communication network to setup the requested network slice/communication service guarantees.

5. The method according to claim 1, wherein network-related requirements are represented by at least one parameter of latency, bandwidth, availability and error rate.

6. The method according to claim 1, wherein the scheduling decision of mapping of application components to compute nodes is based on best effort or some heuristics performed by the scheduling function means and sending it to the network control function means for verification.

7. The method according to claim 1, wherein a connectivity matrix is used by the scheduling function means for approximately checking whether the network-related requirements can be fulfilled for a chosen schedule.

8. The method according to claim 1, wherein a prediction performed by the scheduling function means whether a chosen deployment will work from a network point of view is considered.

9. The method according to claim 1, wherein the network is divided into parts and several network controlling function means are provided each controlling one of the parts of the network.

10. The method according to claim 1, wherein several application orchestration instances are provided each scheduling application components on its assigned infrastructure, the respective infrastructure overlapping with the infrastructure of at least one different instance at least in part.

11. The method according to claim 1, wherein a network probe is installed on each compute node or a subset of compute nodes monitoring network conditions and properties and communicating them to the scheduling function means or the network controlling function means.

12. The method according to claim 1, wherein the network communication services are setup by the compute nodes themselves.

13. The method according to claim 1, wherein compute delays in the compute nodes are considered by the scheduling function means to calculate end-to-end delays between a set of workloads and interfaces Iⱼₖ between them.

14. The method according to claim 13, wherein reservations for the real-time workloads and data flows are to be provided with the underlying infrastructure.

15. The method according to claim 1, wherein the scheduling function means is either implemented as a custom scheduler or as a component preselecting possible network nodes and interacting with a network controller, and marking them in a deployment file accordingly, before calling the existing scheduler.

16. A software application using the method according to claim 1, wherein the scheduling function means is implemented into a custom scheduler to be integrated into common software tools by providing appropriate extension interfaces.

17. The software application using the method according to claim 1, wherein the scheduling function means is a part of a container orchestrator of a system, which packages the workloads into containers, which are managed during runtime by the container orchestrator.

18. A container orchestration system for mapping industrial applications equipped with a hardware structure and running the method according to claim 1.
